(19) United States
(12) Patent Application Publication
(10) Pub. No.: US 2014/0035783 A1
(43) Pub. Date: Feb. 6, 2014

(54) Multi-beam antenna array for protecting GPS receivers from jamming and spoofing signals

(71) Applicants: Vincent M. Contarino, Lusby, MD (US); Pavlo Molchanov, Lexington Park, MD (US)

(72) Inventors: Vincent M. Contarino, Lusby, MD (US); Pavlo Molchanov, Lexington Park, MD (US)

(21) Appl. No.: 13/562,313

(22) Filed: Jul. 31, 2012

(51) Int. Cl. G01S 19/21

(52) U.S. Cl. 342/357.59

(57) ABSTRACT

Multi-beam antenna array for anti jam and anti-spoof protection of GPS satellite data using multiple directional antennas disposed in various orientations jamming or spoofing signals from any direction cannot damage all said directional antennas simultaneously. Each said directional antenna connected to filtering amplifier and to multiple GPS processors for calculating direction of signal arrival. An anti-jam/anti-spoof processor comparing directions of signals arrival with real satellites positions for arrival time from data storage filters signals from jamming or spoofing signals, which are not corresponding to the correct positions stored for each satellite at the transmit time.

### CROSS REFERENCE TO RELATED APPLICATIONS

Not applicable

### BACKGROUND OF THE INVENTION

1. Field

The present invention relates generally to anti jam and anti-spoof protection of a receiver and transmitter system, receiving data from multiple directions and transmitting data in multiple directions. More particularly, the present invention relates to a method for anti jamming and anti-spoofing Global Positioning Systems (GPS) satellites including calculating the direction of a satellite signal arrival utilizing a multi-beam directional antenna array and excluding sources not corresponding to the stored data of satellites position at the time of signal arrival.

2. Background

The reliability of navigation data is a key element in many situations today. Therefore, a key principle for receiving devices, in particular, GPS receivers, is providing accurate navigation information relating to position and timing. In order to provide accurate information, GPS receivers commonly use broad antenna gain patterns so that all of the satellites above the horizon can be tracked. Unfortunately, a broad antenna gain pattern, increases the susceptibility of GPS receivers to receive jamming signals or spoofing signals.

A jamming signal transmitted to a GPS receiver is intended to disrupt the receiving capabilities of the receiver and further interrupt the availability of a valid signal at the receiver. A jammed receiver will not be able to decode any signal, nor be able to provide accurate position or time data. Similarly, the transmission of data from a GPS transmitter is inhibited in the presence of a jamming signal.

On the other hand, spoofing occurs when a signal provides incorrect or misleading information to the receiver. The receiver, in turn, utilizes this signal to calculate inaccurate position and time data. A misleading position results from the successful transmission of a spoofing signal.

In general, electromagnetic signals have the ability to be recorded. Since these signals can be recorded, a spoofing signal may be the retransmission of a previously recorded signal. This retransmission of a recorded signal makes it difficult to differentiate from a properly transmitted signal.

Overall, jamming and spoofing, together or separately, can force a GPS system below a pre-determined reliability threshold. Certain scenarios, both from a navigational or military perspective require an extremely high level of accuracy. Examples of such scenarios could include those within the area of aircraft navigation. GPS systems are use in many phases of aircraft navigation, specifically in aircraft positioning, approach and departure paths, course timing as well as vertical positioning. Any interference that reduces from this high level of accuracy could endanger public safety, military actions or government systems.

Current Controlled Reception Pattern Antenna (CRPA) systems are being used with GPS receivers for electronic protection in electromagnetically-challenged environments. These environments may contain signal interference from natural electromagnetic signals as well as generated electromagnetic signals. These systems are based on simple null steering that adapts antenna weights to steer nulls along the interfering signal direction with no constraint on the antenna response in the direction of a satellite signal. In these systems interfering signals are nulled while the antenna response is constrained in the direction of individual satellite directions.

CRPA systems have a few main disadvantages when applied to GPS systems:

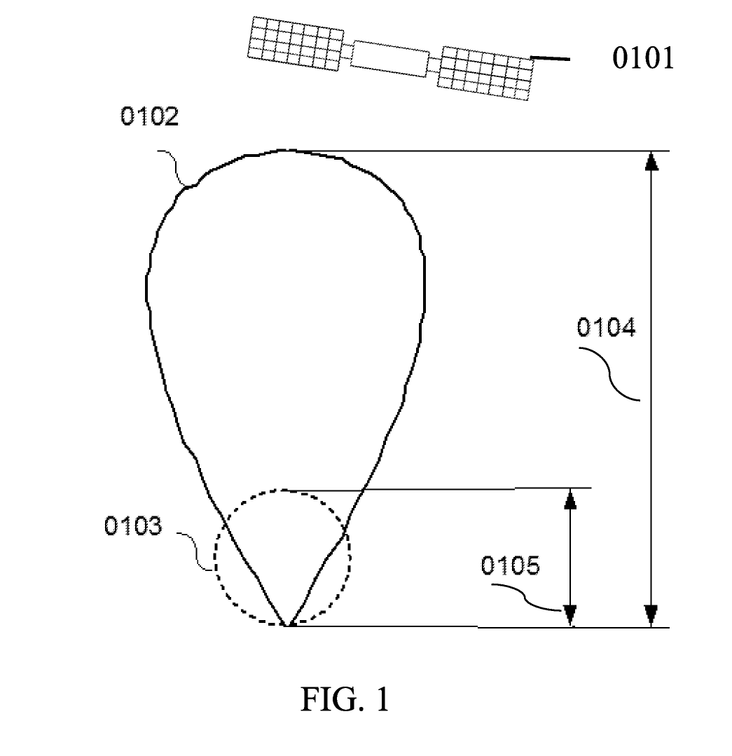

1. Every antenna element in planar omni-directional antenna array will be exposed to a jamming signal and each filtering low noise amplifier (FLNA) can be damaged or reaches a certain level of saturation (FIG. 1). Null forming algorithms cannot help in avoiding this because an FLNA can be damaged before a feedback signal will change a receivers element weight.

2. A planar phased array cannot have a high level gain at low azimuth angles or when a GPS satellite is near the horizon from the perspective of the array.

3. Omni-directional antennas are very susceptible to jamming or spoofing. With respect to jamming, any positioning of a jamming signal will enter the receiver area of a phased array or single antenna. Similarly, with spoofing, such as with military encryption schemes, a spoofing signal can be recorded and repeat real satellite signals with a delay. Receivers receiving the spoofed signal will calculate improper location and time data.

With respect to current GPS systems, in light of jamming and spoofing signals, the reliance on GPS data can be compromised under this approach.

### BRIEF SUMMARY OF THE INVENTION

Broadly conceptualized, a preferred embodiment of the present invention provides a method and apparatus for identifying, recording and ignoring electromagnetic signal interference. In one advantageous embodiment, a method is provided for an anti-jamming and anti-spoofing protection solution. A protection solution is provided by eliminating jamming and spoofing signals using a signal processor. A protection solution is provided by calculating signals received from a multi-beam, directional antenna array. The multi-beam directional antenna array, comprise of any number of antenna elements greater than or equal to 2, receives all signals, including known signals with predetermined frequency and encryption codes, and those signals that will later be identified as interference. A protection system of a global positioning system signal compares signals using a repository of information storing data of known position, frequency, encryption, and time data. The known data is compared against signals received by the protection system. A matching list of known and desired signals is extracted from all signals received by a protection system. Signals not matching the data stored in an informational repository are identified by the protection system.

A particular area of applicability for a preferred embodiment of the present invention is a method relating to Global Positioning Systems, (GPS). The multi-beam directional antenna array receives signals from a directed field of view, or collection of GPS satellites, with each satellite having a known navigational position and time position in relation to the multi-beam directional antenna. This directed view allows each antenna within the multi-beam directional antenna array to ignore signals outside said antennas focus. With each antenna focused in a particular direction, the collection of all signals received from a determined field of coverage is divided into subsets for ease of processing.

A preferred embodiment of the present invention provides a method for calculating aspects of interference signals to identify said signals as jamming signals or spoofing signals. This preferred method comprises:

receiving electromagnetic signals using a multi-beam directional antenna array;

identifying characteristics of said electromagnetic signals for classification in categories further comprising jamming signals, spoofing signals and accepted signals;

calculating the amplitude of each signal within the collection of signals collected by each antenna within a multi-beam directional antenna array; storing electromagnetic signal data of desirable amplitudes for further processing; storing location, amplitude, frequency, encryption and time data of signals outside a desirable amplitude range for further processing as jamming signals; calculating location data and direction of arrival (DOA) data from each signal that succeeded from prior comparison to desirable amplitudes;

comparing location data and direction of arrival (DOA) data from each remaining electromagnetic signal to a known repository of location data for said signal; processing electromagnetic signals that match location data and direction of arrival (DOA) from of known locations and directions for delivery of accurate position data; and identifying location, direction of arrival (DOA) and time data of electromagnetic signals that do not match known locations from a known repository and identifying said electromagnetic signals as spoofing signals to further identify positional data of sources of spoofing signals.

In another advantageous embodiment, an apparatus comprising a navigational protection system, a multi-beam directional antenna array, a global positioning system signal processing unit, and an anti jamming signal processor, an anti-spoofing signal processor, an array support structure is disclosed.

In yet another advantageous embodiment, an apparatus comprising a navigational protection system, a multi-beam directional antenna array, a global positioning system signal processing unit, an anti jamming signal processor, an anti-spoofing signal processor and a dielectric lens layer.

In yet another advantageous embodiment, an apparatus comprising a navigational protection system, a multi-beam directional antenna array, a global positioning system signal processing unit, an anti jamming signal processor, an anti-spoofing signal processor and a dielectric lens layer wherein the orientation of said multi-beam directional antenna array is hemispherical, extending coverage by way of directional antennas in a spherical form around a set of GPS receivers. Said hemispherical orientation provides multi-beam directional antenna coverage in all directions regardless of the orientation of the device or support structure containing said GPS receivers. This advantageous embodiment may be applicable in area where GPS receivers do not maintain a constant orientation such as in wireless transmit/receive units (WTRUs), cell phones, tablets, PDAs and other devices that are mobile in nature.

In yet another advantageous embodiment, a method of transmitting data from a multi-beam directional antenna array by identifying antennas within said array which are receiving jamming signals and/or spoofing signals. With the presence of n jamming units, any multi-beam directional antenna array could transmit data with n+1 antenna elements.

The preferred embodiments are fully disclosed below, albeit without placing limitations thereon and with this in mind, different advantageous embodiments may provide different advantages as compared to other advantageous embodiments. The principles of the present invention are described in detail, through drawing and description in order to best describe the advantageous embodiments, the utility of said present invention and to enable others of ordinary skill in the art to understand the disclosure so as to be able to apply the various embodiments to a particular contemplated use.

### BRIEF DESCRIPTION OF DRAWINGS

1. FIG. 1 is a diagram illustrating the electromagnetic signal gain advantage of a directional antenna over that of an omni-directional antenna.

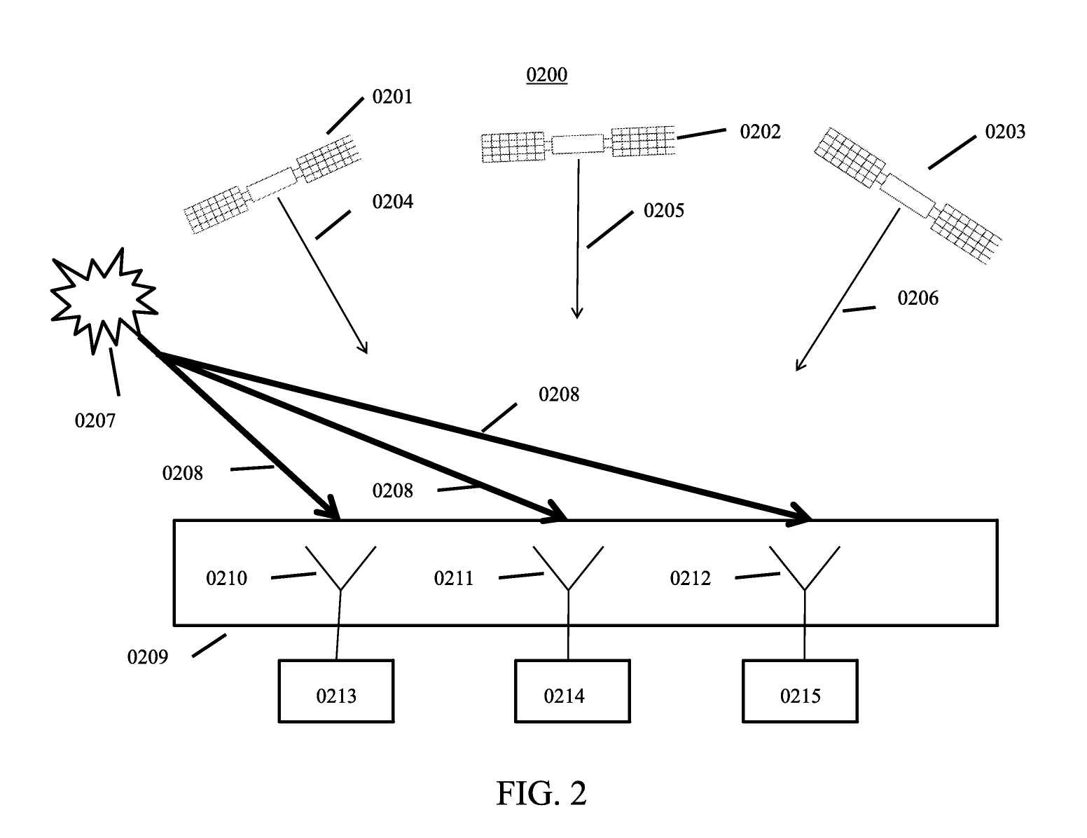

2. FIG. 2 represents a diagram illustrating a disadvantageous scenario where each and every antenna of a phased omni-directional antenna array is receiving a jamming signal or a spoofing signal from a single jamming or spoofing unit.

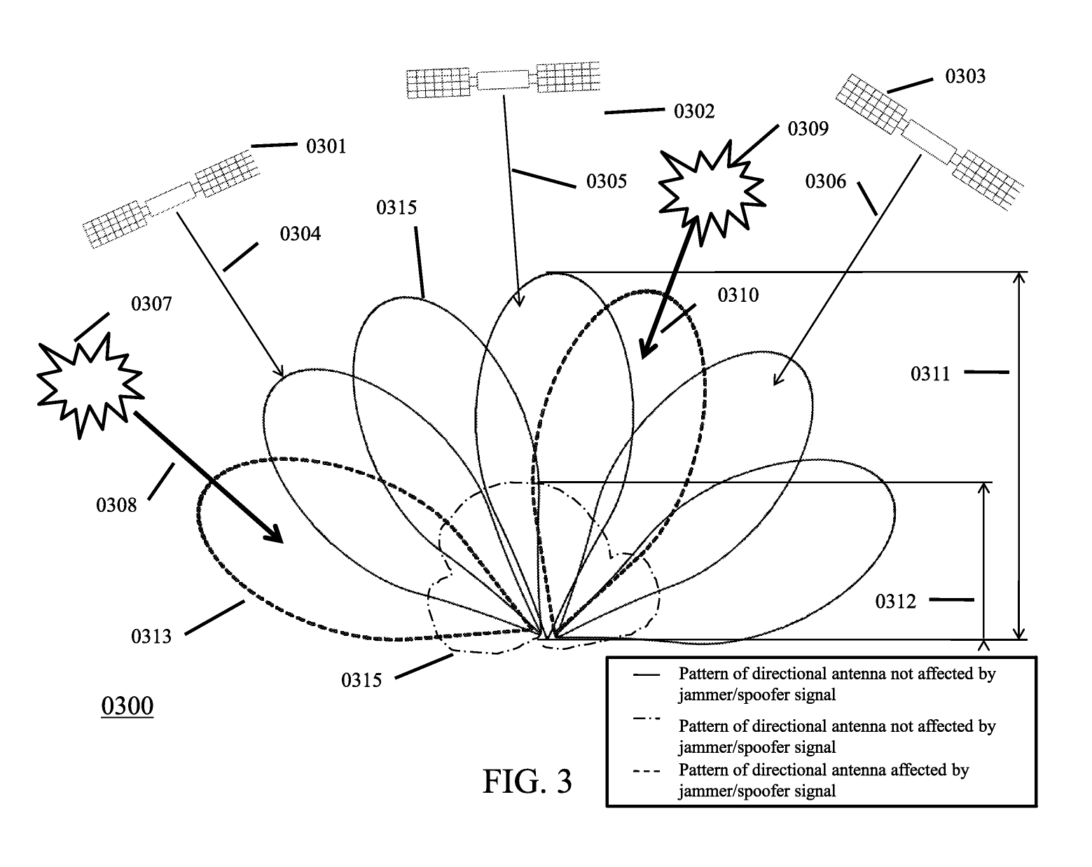

3. FIG. 3 represents the advantage of a preferred embodiment of the present invention over the prior art.

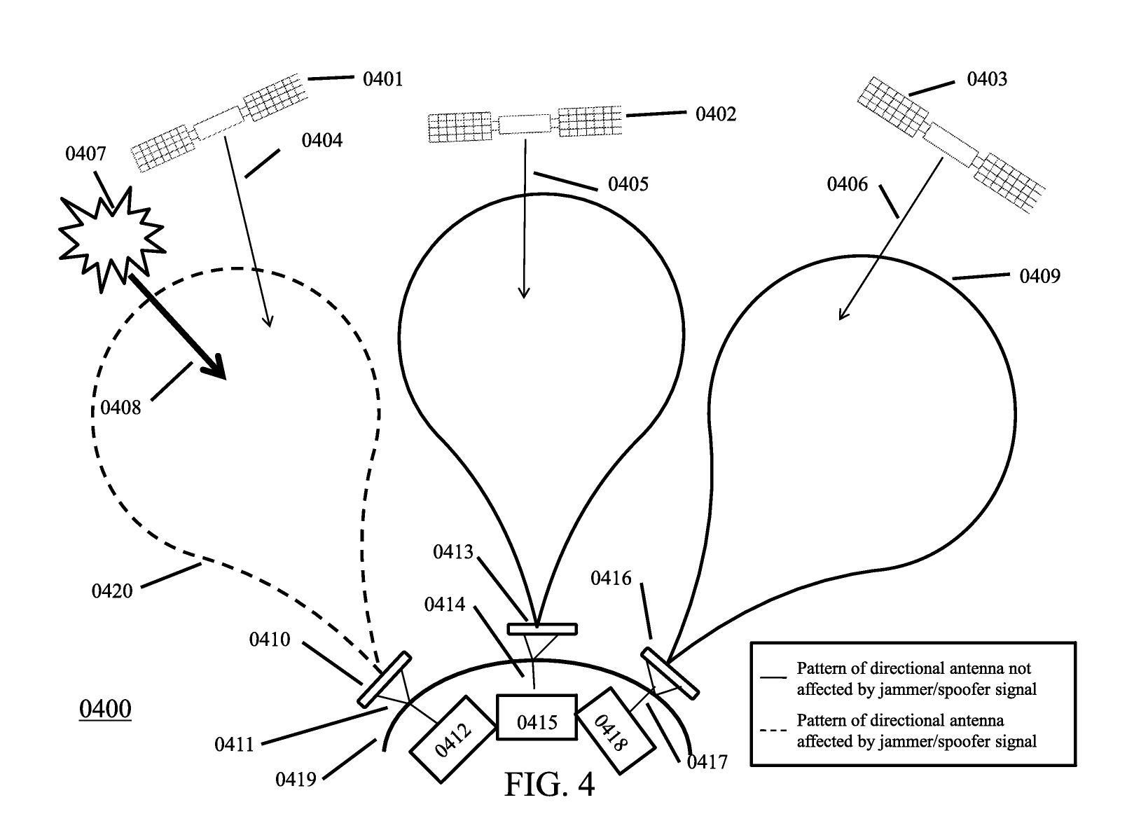

4. FIG. 4 represents a multi-beam, directional antenna array disposed in a concave surface and the behavior of an advantageous embodiment of the present invention.

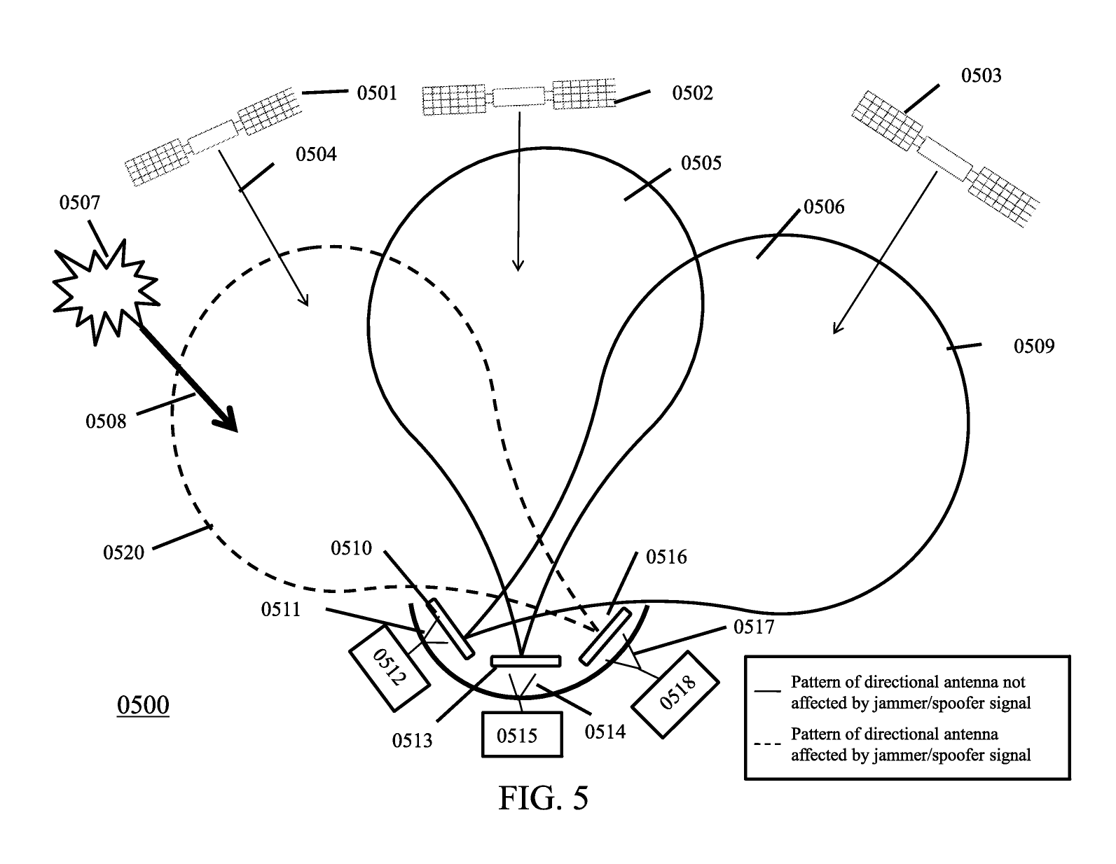

5. FIG. 5 represents a multi-beam, directional antenna array disposed in a convex surface and the behavior of an advantageous embodiment of the present invention.

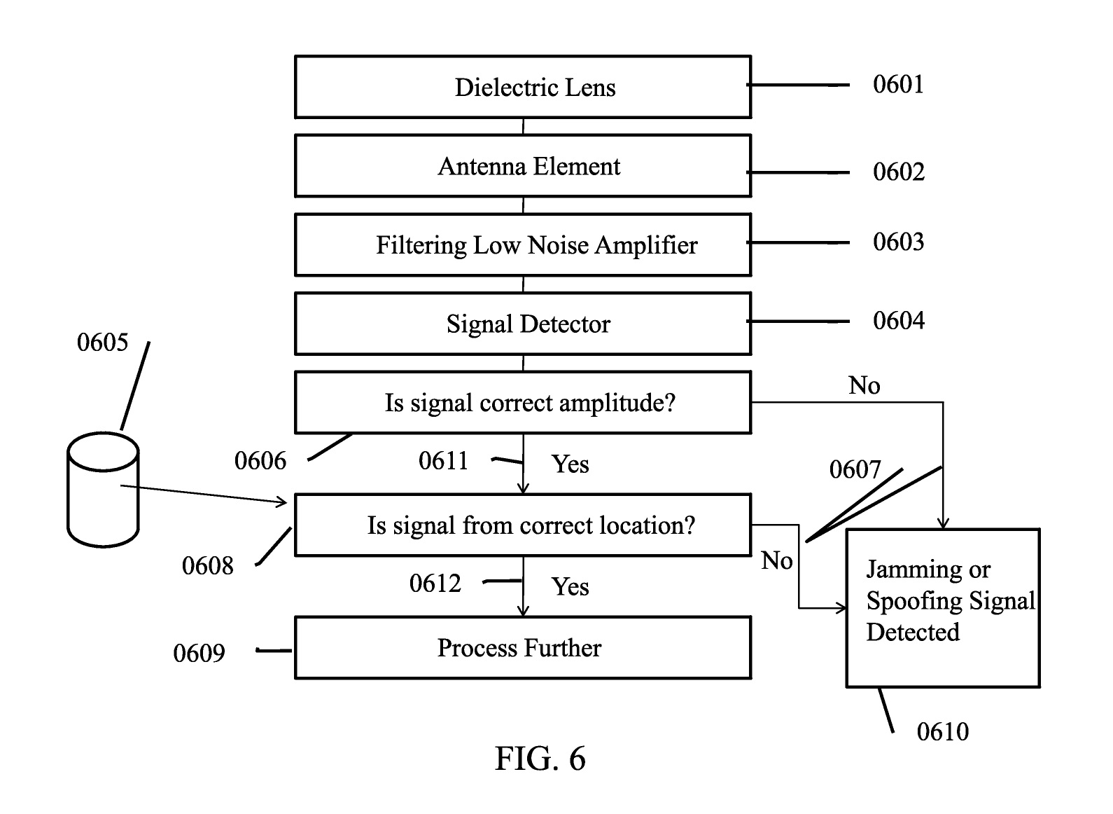

6. FIG. 6. represents a flowchart of a process for generating a protection solution in accordance with an advantageous embodiment of the present invention.

### DETAILED DESCRIPTION

With reference now to the figures, beginning in kind with FIG. 1, a diagram illustrating the electromagnetic signal gain advantage of a directional antenna 0104 over that of an omni-directional antenna 0105 is depicted in the context of a global positioning system (GPS) 0101 to demonstrate the advantage over the prior art. Omni-directional antennas 0103 are advantageous in scenarios where a spherical receiving pattern is desirable. However, with the directional antennas 0102 a significant advantage in terms of gain can be achieved.

FIG. 2 depicts a omni-directional phased array of null steering antennas 0209. With a system of GPS satellites 0201, 0202, and 0203, for example, delivering electromagnetic signals of location and time data in signals 0204, 0205, and 0206 respectively, a jamming or spoofing unit 0207 broadcasting a jamming or spoofing signal 208 can effectively saturate each element 0210, 0211, 0212 of the omni-directional phased array 0209. A saturation of the omni-directional phased array could cause damage to each element of the omni-directional phased array and subsequently causing damage to the filtering low-noise amplifiers 0213, 0214 and 0215, listening to the broadcast of said signal. Said saturation is highly undesirable and a major disadvantage of the prior art.

In quantifying the difference between an omni-directional phased array and a multi-beam directional antenna array, FIG. 3. offers a comparison of an overall gain advantage by using a multi-beam directional antenna array 0311 over using an omni-directional phased array 0312. Further, FIG. 3 depicts an arrangement of GPS satellites 0301, 0302 and 0303 transmitting electromagnetic signals 0304, 0305 and 0306 respectively. The pattern of gain range of each directional antenna element of the multi-beam directional antenna array is depicted and further describes two separate scenarios for said array. Jamming or Spoofing units 0307, 0309 are simultaneously transmitting jamming or spoofing signals 0308, 0310 respectively. Said signals are directed toward the multi-beam directional antenna array. Jamming and Spoofing signals are identified by the protection system of the present invention and the multi-beam directional antenna array is still not affected 0315 entirely even if two elements of the multi-beam directional antenna array are affected 0313.

In FIG. 4 a convex support structure arrangement 0419 is depicted utilizing three directional antenna elements 0411, 0414, 0417 within the multi-beam directional antenna array. A dielectric lens 0410, 0413, 0416 provides an additional layer of complexity to the reception of the electromagnetic signals. The dielectric lens is constructed of a material that converges or diverges a beam of an electromagnetic signal. The dielectric lens allows an electromagnetic signal that is too great in amplitude for the receiver element to be focused upon said element. This focused electromagnetic signal data is aided by a filtering low-noise amplifier 0412, 0415, 0418 to provide a sufficient signal for processing to the GPS signal processor and hence the anti jam and anti-spoofing processor of the present invention. A jamming or spoofing unit 0407 which emits an electromagnetic signal 0408 will be unable to affect the receiving abilities of multiple members of the multi-beam directional antenna array 0409 since the directional nature of elements 0414 and 0417 do not receive signals in the direction of the jamming or spoofing signal 0408. The GPS satellites 0401, 0402, 0403, may continue to communicate with the elements of the multi-beam directional antenna array by transmitting signals 0404, 0405, 0406. The advantage of the concave structure support element provides a wide coverage angle for the array and receives signals in an expansive direction. An advantage of said coverage is that the low azimuth angle limitation of an omni-directional antenna is overcome by directing an element of said multi-beam directional array in the direction of the horizon. The pattern of coverage 509 of an element of said array could better cover the delivery of a GPS satellite signal from the horizon in relation to the position of said array.

In FIG. 5 a convex support structure arrangement 0520 is depicted utilizing three directional antenna elements 0511, 0514, 0517 within the multi-beam directional antenna array. A dielectric lens 0510, 0513, 0516 provides an additional layer of complexity to the reception of the electromagnetic signals. The dielectric lens is constructed of a material that converges or diverges a beam of an electromagnetic signal. The dielectric lens allows an electromagnetic signal that is too great in amplitude for the receiver element to be focused upon said element. This focused electromagnetic signal data is aided by a filtering low-noise amplifier 0512, 0515, 0518 to provide a sufficient signal for processing to the GPS signal processor and hence the anti jam and anti-spoofing processor of the present invention. A jamming or spoofing unit 0507 which emits an electromagnetic signal 0508 will be unable to affect the receiving abilities of multiple members of the multi-beam directional antenna array 0509 since the directional nature of elements 0514 and 0517 do not receive signals in the direction of the jamming or spoofing signal 0508. The GPS satellites 0501, 0502, 0503, may continue to communicate with the elements of the multi-beam directional antenna array by transmitting signals 0504, 0505, 0506.

In FIG. 6, a dielectric lens 0601 receives is the first receiving element of an electromagnetic signal which, as described above, focuses said signal upon the antenna element 0602 at a known angle. With a known value focusing said signal upon the antenna element, signals outside the focus of said element can be ignored. A filtering low-noise amplifier 0603 amplifies the gain of a received electromagnetic signal and act to reduce the noise contained within said signal. The signal detector 0604 processes the direction of arrival (DOA), location data and amplitude of the received electromagnetic signal for further processing by the anti jamming decision process 0606 and 0608. If a signal has a correct amplitude as has been predetermined by a threshold within the system, the signal is identified for further processing 0611. If a signal does not have a proper amplitude, the signal is identified for further processing as a jamming signal or a spoofing signal 0607. Once a signal has been properly filtered for correct amplitude, a comparison of the received signal 0608 is conducted against known location data from a repository of information 0605 relating to the correct location of the signal that has been provided. Elements such as direction of location (DOA), location, and time data are compared against known positions. If a received signal matches a known signal 0612, the signal is processed 0609 for delivery to a GPS receiver. If the comparison of the data in the known repository and the received signal is not a match, the signal is identified as a spoofing signal 0607 and is stored for further processing to determine the location of said spoofing signal.

What is claimed is:

1. A method of protecting GPS satellite data from multiple directions comprising:
Receiving signals from multiple satellites and sources by multiple directional antennas disposed in various orientations on convex or concave support structures so one jam signal from any direction cannot damage all said directional antennas simultaneously;
Filtering and amplifying GPS satellites signals received from each separate directional antenna;
Excluding signals received from separate directional antennas if level of signal exceeds a determined threshold;
Calculating direction of signals arrival and position information from said satellites data by GPS processors.

2. Method of claim 1, wherein:
Anti jamming and anti-spoofing processor comparing directions of a signal arrival with real satellite positions from repository of known data about satellite position;
Anti jamming and anti-spoofing processor excluding information from jamming or spoofing sources or satellites not corresponding to directions received from said repository of data about satellite position;

3. Multi-beam antenna array for anti jam and anti-spoof detecting GPS satellite data comprising:
multiple directional antennas disposed in various orientations for receiving GPS satellites signals;
multiple filtering low-noise amplifiers coupled to each directional antenna;
multiple GPS processors for calculating directions of signal arrival and position information having serial output interface where outputs of said multiple filtering amplifiers coupled to said multiple GPS processors;
anti jamming and anti-spoofing processor connected to outputs of said multiple GPS processors;
a repository of data relating to satellite positions connected to anti jamming and anti-spoofing processor, which excluding information from sources not corresponding to directions received from said repository of data about satellite position;

4. Multi-beam antenna array of claim 3, wherein:
Said multiple directional antennas disposed on convex or concave surface for maximal cover possible GPS satellites area by directional antennas patterns;
Said directional antennas disposed so jam signal from any direction cannot damage all said directional antennas simultaneously;
Said multiple directional antennas having right hand circular polarization.

5. Multi-beam antenna array of claim 4, wherein:
Said multiple directional antennas comprising switching or limiting signal fixtures for excluding or limiting input signals connected to anti jam processor.

6. Multi-beam antenna array of claim 5, wherein:
Said multiple directional antennas comprising beam forming dielectric lens cover for focusing directional antennas patterns and matching.
